(19) United States
(12) Patent Application Publication
(10) Pub. No.: US 2008/0285737 A1
(43) Pub. Date: Nov. 20, 2008

(54) Methods, systems, and computer program products for point code proxying between signaling points

(75) Inventors: Devesh Agarwal, Raleigh, NC (US); Michael Y. Xu, Raleigh, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/890,552

(22) Filed: Aug. 6, 2007

Related U.S. Application Data
(60) Provisional application No. 60/930,627, filed on May 17, 2007.

(51) Int. Cl. H04M 7/00

(52) U.S. Cl. 379/230

(57) ABSTRACT

The subject matter described herein includes methods, systems, and computer program products for point code proxying. According to one method, a direct linkset interconnection between first and second signaling points is migrated to an interconnection including signaling message routing node. At the signaling message routing node, a point code of the second signaling point is proxied for link alignment with the first signaling point. Messages received from the first signaling point that are addressed to the point code of the second signaling point are routed to the second signaling point.

### RELATED APPLICATIONS

This application claims the benefit of U.S. Provisional Patent Application Ser. No. 60/930,627, filed May 17, 2007; the disclosure of which is incorporated herein by reference in its entirety.

### TECHNICAL FIELD

The subject matter described herein relates to establishing connections between signaling points in a communications network. More particularly, the subject matter described herein relates to methods, systems, and computer program products for providing point code proxying between signaling points.

### BACKGROUND

In SS7 networks, signaling points or nodes are typically identified by one or more point codes. Point codes are used for signaling message addressing, signaling message routing and signaling link alignment. In signaling message addressing for message origination, a signaling point may be provisioned with the point code to use in the destination point code (DPC) field of signaling messages that the signaling point originates and sends to another signaling point. Signaling message routing involves selecting a linkset over which a received message should be forwarded based on the DPC value of the message. Signaling message routing is typically effected by performing a lookup in a route table to identify the linkset associated with the destination point code in the signaling message. Route tables may be provisioned by a network operator when a node is brought into service.

Signaling link alignment is the process by two nodes connected to each end of the signaling link agree on timing in order to delineate boundaries of messages sent over the signaling link. In SS7 networks, signaling link alignment is performed by message transfer part (MTP) level 2. When a signaling link is misaligned, the two nodes connected to each end of the link cannot properly delineate message boundaries. Link alignment involves the sending of link status signaling units (LSSUs) to establish the proper message boundaries on a signaling link. Signaling link alignment must be performed before traffic can be sent over a signaling link. Signaling link alignment is performed on a per-link basis and must be performed before traffic can be sent over a signaling link.

In order to provision a node for signaling link alignment, the node needs to know the point code of the node connected to the far end of a signaling link. This is accomplished by having an operator manually provision the point code of the node connected to the far end of the signaling link. Because this point code is typically the node that is directly adjacent to the signaling node being provisioned, this point code is often referred to as the adjacent point code (APC).

Under current network architectures, when two nodes are directly connected, the point code that each node uses in addressing and sending messages to the other node is the same as the point code that each node uses for link alignment. FIG. 1A illustrates this configuration. In FIG. 1A, signaling point 100 is connected to signaling point 102 by signaling linkset 104. For example, signaling points 100 and 102 may be end office or tandem office switches that are connected via signaling linkset 104. In the illustrated example, it is assumed that signaling point 100 is identified by point code A and signaling point 102 is identified by point code B. For alignment of signaling links in linkset 104, signaling point 100 is provisioned with point code B as the adjacent point code. Similarly, signaling point 102 is provisioned with point code A for alignment of signaling links in signaling linkset 104. For originating messages to signaling point 102, signaling point 100 is configured to use the same point code that it uses for link alignment, i.e., point code B. Signaling point 102 is provisioned to address messages to signaling point 100 using point code A.

In order to simplify network connections, it may be desirable to insert an intermediate node in between signaling points 100 and 102 to perform signaling message routing. For example, a signaling message routing node may be used to simplify interconnections between nodes that are connected in star or mesh topologies where every node has a direct linkset interconnection with every other node. In the present example, a signaling message routing node replaces a single direct linkset interconnection between two nodes. Referring to FIG. 1B, a signaling message routing node 106, which may be a signal transfer point, is inserted between nodes 100 and 102. It is also assumed that signaling message routing node 106 is operated by an operator of one network, labeled “home network” in FIG. 1B and that signaling point 100 is operated by a different network operator, whose network is labeled “foreign network”. In FIG. 1B, linkset 104 illustrated in FIG. 1A has been replaced by linksets 108 and 110. In the home network, the operator of signaling point 102 must provision a new adjacent point code with signaling point 102 for link alignment purposes. In the illustrated example, this point code is point code C, which identifies signaling message routing node 106. Similarly, the operator of the foreign network must also provision point code C for link alignment purposes. Neither network operator is required to change the point code for sending messages between nodes A and B.

One problem with the scenario illustrated in FIG. 1B for the operator of the home network is that the operator of the home network may not be able to force the operator of the foreign network to change the adjacent point code on every signaling link connected to the home network. Even if the operator of the home network can force the operator of the foreign network to change all of the adjacent point codes, this operation may be burdensome on the operator of the foreign network because the foreign network may have hundreds of switches and therefore hundreds of adjacent point codes to reconfigure.

The problem of requiring the operator of the foreign network to reprovision multiple adjacent point codes for link alignment purposes is illustrated in FIGS. 2A and 2B. In FIG. 2A, signaling point 100 in the foreign network is directly connected via linksets 112, 114, and 116 to switches 102A, 102B, and 102C in the home network. In the home network, switches 102A, 102B, and 102C are connected in a mesh configuration via signaling links 118, 120, and 122. In this situation, it may be desirable for the operator of the home network to replace the mesh interconnection where each node is connected to every other node with an interconnection including signaling message routing node 106, as illustrated in FIG. 2B.

In FIG. 2B, routing node 106 is connected to signaling points 102A, 102B, and 102C via linksets 122, 124, and 126. Routing node 106 is connected to signaling point 100 via linkset 127. The adjacent point code on signaling point link 127 from the perspective of node 100 must be changed from point codes B1, B2, and B3 to C, the point code of signaling message routing node 106. The operator of the foreign network may be unwilling to make these changes or may at the least charge the operator of the home network for making these changes. Accordingly, requiring that the APC be changed is undesirable. In addition, as the number of interconnected nodes between the foreign and home networks increases, the amount of work that must be performed by the operator of the foreign network upon changes in the interconnections increases.

Accordingly, in light of these difficulties, there exists a need for facilitating migration of signaling linksets from direct interconnection between nodes to interconnection via one or more intermediate nodes that reduces the burden on the network operators with regard to provisioning of point codes for link alignment purposes.

Another problem that is related to the problem of requiring reprovisioning of adjacent point codes for link alignment purposes during link migration is the problem of providing IP signaling link interconnection to remote nodes. Currently, most SS7 signaling links are time division multiplexed (TDM) based. It may be desirable to migrate this older TDM-based equipment to IP-based equipment, because the IP-based equipment is lower in cost on a per signaling link basis. However, smaller operators may be unwilling to replace an installed base of TDM equipment with IP equipment due to the one-time cost of such replacement. Accordingly, edge nodes are often used to convert between TDM-based signaling links and IP-based signaling links. An edge node may be a relatively inexpensive (as compared to switching office upgrades) piece of equipment whose function is to convert between TDM-based signaling message transport and IP-based signaling message transport. Placing an edge node in between two signaling points may present the same adjacent point code reprovisioning problem described above with regard to TDM-based signaling links because the edge node, when used with reliable SIGTRAN protocols, requires its own point code, which adjacent nodes must provision for link alignment. In addition, in non-North-American networks that use ITU SS7 protocols, point codes are scarce. Thus, a new point code may not be available for the edge device.

FIGS. 3A and 3B illustrate these problems in more detail. In FIG. 3A, nodes 100 and 102 are connected via a TDM signaling linkset 104 as illustrated in FIG. 1A. In FIG. 3B, TDM-based signaling linkset 104, is replaced by a TDM linkset between signaling point 100 and edge device 128 and an IP link between edge device 128 and signaling message routing node 106. Edge device 128 uses the point code D to identify itself. Edge device 128 includes a TDM interface that connects to TDM linkset, which connects to linkset 104 with signaling point 100. In addition, edge device 128 includes an MTP2-user peer-to-peer adaptation layer (M2PA) interface that connects to SS7 over IP linkset 130, which connects to signaling message routing node 106. One problem with using the M2PA protocol is that it requires point codes on each end of an M2PA signaling link. Accordingly, the operator of node 100 must provision a new point code, point code D, for link alignment on linkset 104. Similarly, the operator of signaling point 102 must provision a new point code, point code C, for link alignment on signaling linkset 132. Thus, the same problems described above with regard to TDM-based interfaces of requiring the reprovisioning of adjacent point codes for link alignment purposes occurs in IP networks as well. In addition, in international networks, point codes may be scarce, meaning that a separate point code may not be available for edge device 128.

Accordingly, in light of these difficulties, there exists a need for methods, systems, and computer program products for point code proxying between signaling points.

### SUMMARY

The subject matter described herein includes methods, systems, and computer program products for point code proxying. According to one method, a direct linkset interconnection between first and second signaling points is migrated to an interconnection including signaling message routing node. At the signaling message routing node, a point code of the second signaling point is proxied for link alignment with the first signaling point. Messages received from the first signaling point that are addressed to the point code of the second signaling point are routed to the second signaling point.

According to another aspect, the subject matter described herein includes a system for point code proxying. The system includes first and second signaling link interfaces for migrating a direct linkset interconnection between first and second signaling points to an interconnection including a signaling message routing node. The system includes a point code proxying function for proxying a point code of the second signaling point for link alignment with the first signaling point. A routing function routes messages received from the first signaling point that are addressed to the point code of the second signaling point to the second signaling point.

According to another aspect, the subject matter described herein includes an edge device with point code proxying capability. The edge device includes a time division multiplexed (TDM) signaling link interface for interfacing with a TDM-based signaling linkset. The edge device further includes an Internet protocol (IP)-based signaling link interface for interfacing with an IP-based signaling linkset. The edge device further includes a point code proxying function for proxying a point code of a node reachable via the IP-based signaling linkset for alignment of signaling links in the TDM-based signaling linkset and for proxying a point code of a node reachable via the TDM-based signaling linkset for link alignment of signaling links in the IP-based signaling linkset.

The subject matter described herein for providing point code proxying between signaling points may be implemented using a computer program product comprising computer executable instructions embodied in a computer readable medium. Exemplary computer readable media suitable for implementing the subject matter described herein includes disk memory devices, programmable logic devices, application specific integrated circuits, and downloadable electrical signals. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1A is a network diagram illustrating direct interconnection of two nodes via a signaling linkset;

FIG. 1B is a network diagram illustrating interconnection between two nodes in different networks using a signaling message routing node and different linksets;

FIG. 2A is a network diagram illustrating interconnection of multiple nodes in different networks through direct linkset connections;

FIG. 2B is a network diagram illustrating interconnection of multiple nodes in different networks using a signaling message routing node;

FIG. 3A is a network diagram illustrating direct interconnection of two nodes in different networks via TDM signaling links;

FIG. 3B is a network diagram illustrating interconnection of nodes in different networks using an edge device and M2PA signaling links;

FIG. 4 is a block diagram illustrating interconnection of two nodes in different networks via a signaling message routing node that proxies a point code to the other node on one of the linksets according to an embodiment of the subject matter described herein;

FIG. 5 is a network diagram illustrating interconnection of multiple nodes in different networks via a signaling message routing node where the signaling message routing node point proxies multiple point codes of nodes in one network on linksets that interconnect with nodes in another network according to an embodiment of the subject matter described herein;

FIG. 6 is a network diagram illustrating point code proxying and interconnection of different networks using M2PA links and an edge device according to an embodiment of the subject matter described herein;

FIG. 7 is a block diagram illustrating a signaling message routing node for proxying point codes on first and second IP-based signaling linksets according to an embodiment of the subject matter described herein;

FIG. 8 is a flow chart illustrating an exemplary process for point code proxying according to an embodiment of the subject matter described herein;

FIG. 9 is a network diagram illustrating linkset outages and their effects in a point code proxying environment according to an embodiment of the subject matter described herein;

FIG. 10 is a block diagram illustrating an exemplary internal architecture of a signaling message routing node for providing point code proxying according to an embodiment of the subject matter described herein; and

FIG. 11 is a block diagram illustrating an exemplary internal architecture for edge device with point code proxying capabilities according to an embodiment of the subject matter described herein.

### DETAILED DESCRIPTION

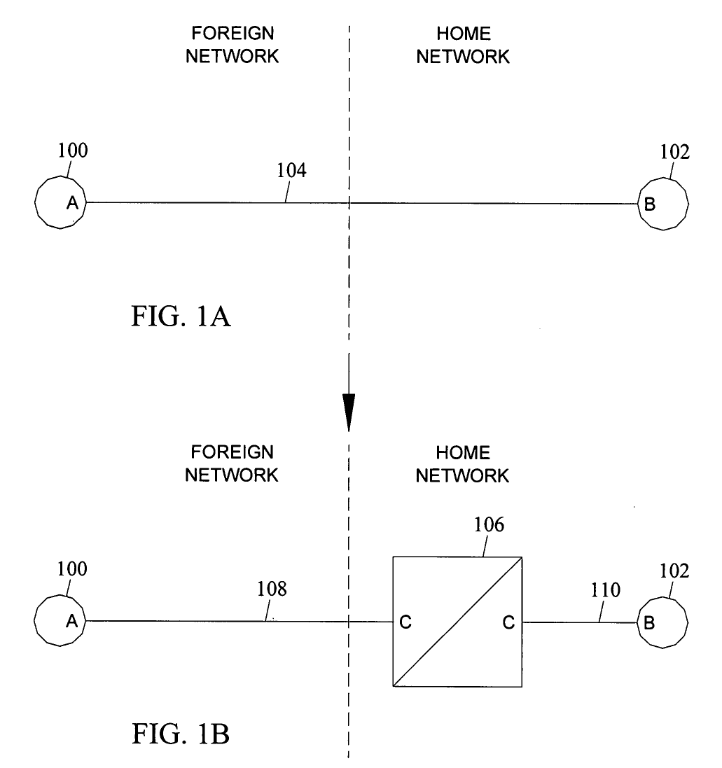

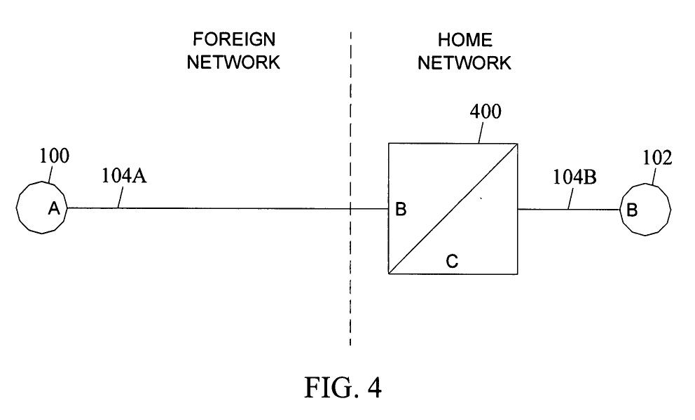

Methods, systems, and computer program products for point code proxying are disclosed. FIG. 4 is a network diagram illustrating an exemplary system for point code proxying when a signaling message routing node is used to replace a direct interconnection via a linkset between signaling nodes in different networks according to an embodiment of the subject matter described herein. Referring to FIG. 4, signaling points 100 and 102 may be any type of SS7 signaling points, such as switches, databases, or signal transfer points. Signaling points 100 and 102 are assumed to have been formerly directly connected via a single linkset 104, as illustrated in FIG. 1A. It is assumed that the operator of the home network adds signaling message routing node 400 to replace the direct linkset interconnection so that signaling points 100 and 102 are now connected via linkset 104A, linkset 104B, and signaling message routing node 400. Signaling message routing node 400 may be a signal transfer point either with or without SS7/IP gateway functionality. As will be described in more detail, an edge device may be utilized to connect the home network and the foreign network via IP signaling links. However, for purposes of this example, it is assumed that linksets 104A and 104B are TDM-based SS7 signaling linksets.

In the illustrated example, it is assumed that signaling point 100 is identified by point code A, signaling point 102 is identified by point code B, and signaling message routing node 400 is identified by point code C. It is also assumed that when signaling points 100 and 102 were directly interconnected, signaling point 100 used point code B for link alignment on former signaling linkset 104 that interconnected the two nodes. According to one exemplary aspect of the subject matter described herein, rather than requiring the operator of the foreign network to reprovision signaling point 100 to use a new adjacent point code, i.e., point code C, for link alignment on linkset 104A, signaling message routing node 400 proxies the point code of signaling point 102 on linkset 104A. Signaling message routing node 400 may also proxy the point code of signaling point 100 on linkset 104B. However, such dual proxying may not be necessary when the same network operator controls both signaling message routing node 400 and signaling point 102 and can configure or reconfigure either node. However, it may be desirable to proxy the point code of signaling point 100 on linksets in the home network if multiple direct interconnections between the networks are being replaced to reduce the amount of work required to be performed by the home network operator.

For message origination, signaling point 100 uses the same point code, i.e., point code B, to send messages to signaling point 102. When signaling message routing node 400 receives a message addressed to point code B, signaling message routing node forwards the message on linkset 104B. Thus, using point code proxying, the operator of the foreign network is not required to reprovision signaling point 100 for link alignment or message origination purposes when a direct interconnection is replaced by a signal transfer point and different linksets.

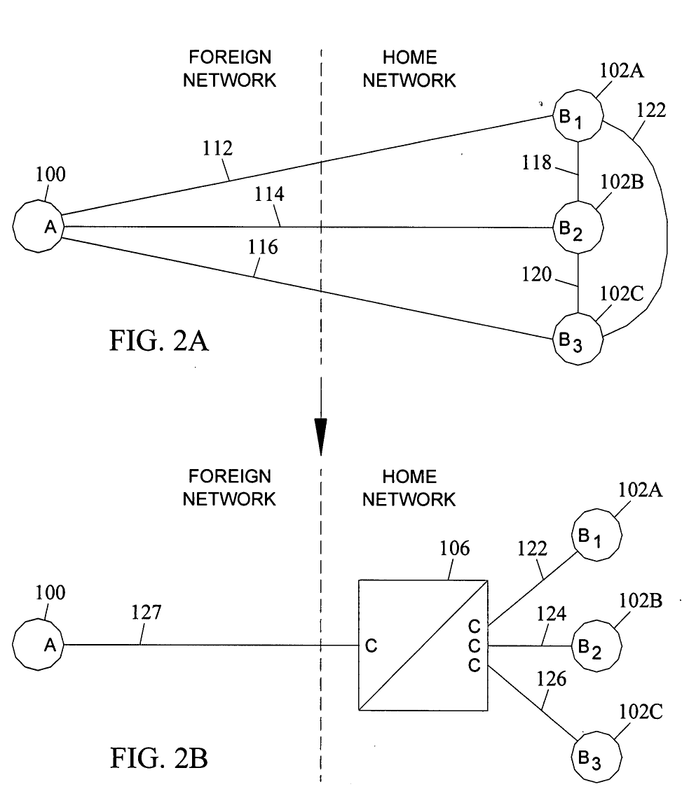

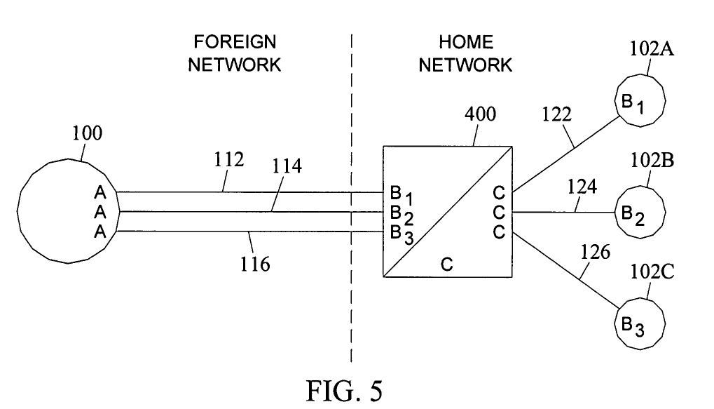

FIG. 5 illustrates an example where signaling message routing node 400 proxies multiple point codes from the home network to signaling point 100 in the foreign network. In this example, it is assumed that the configuration in FIG. 5 replaces direct interconnection as illustrated in FIG. 2A. In FIG. 5, it is assumed that nodes 102A, 102B, and 102C in the home network respectively use point codes B1, B2, and B3. Signaling message routing node 400 uses point code C, and node 100 uses point code A. When the direct interconnection is replaced with signaling message routing node 400, rather than requiring the operator of the foreign network to reprovision adjacent point codes on signaling linksets 112, 114, and 116, signaling message routing node 400 proxies point codes B1, B2, and B3 on signaling linksets 112, 114, and 116. As a result, signaling point 100 can use the same point codes B1, B2, and B3, previously used for link alignment when the nodes were directly connected to signaling point 100. For message origination, signaling point 100 uses point codes B1, B2, and B3 to send messages to nodes 102A, 102B, and 102C.

In the examples described above, it is assumed that the linksets being replaced are TDM linksets. However, the subject matter described herein for proxying point codes may also be used with IP based signaling links where each end of the signaling link is required to have a point code for link alignment purposes. One IP based technology where signaling links are required to have point codes on each end for link alignment purposes is MTP2-user peer-to-peer adaptation layer (M2PA). M2PA is an adaptation layer that resides between the SS7 MTP layers and an IP transport layer, such as stream control transmission protocol (SCTP). M2PA is desirable because it provides reliability mechanisms, such as message sequencing, changeover, changeback, as provided by the SS7 MTP layer 2 protocol. However, the subject matter described herein is not limited to M2PA. Any suitable adaptation layer protocol that requires each end of a signaling link to have a point code for link alignment purposes is intended to be within the scope of the subject matter described herein.

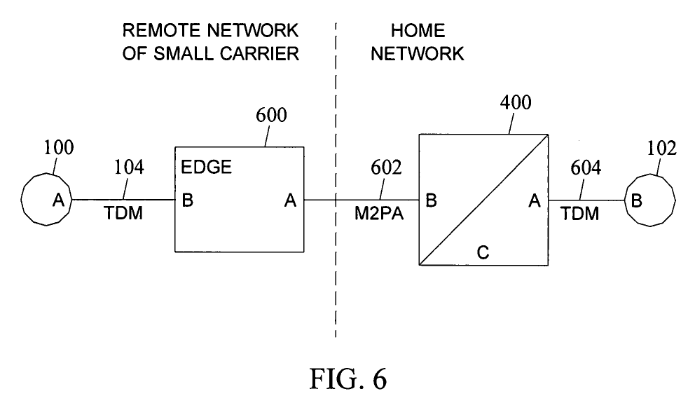

FIG. 6 illustrates an example of point code proxying in an environment where IP-based signaling links are utilized. Referring to FIG. 6, it is assumed that the home network and the foreign were formerly connected via a single TDM linkset, as illustrated in FIG. 1. However, in this example, the foreign network is assumed to be a remote network of a small carrier that may be unwilling to invest in the equipment to reconfigure signaling point 100 to include IP based facilities. Accordingly, an edge device 600 may be utilized for these purposes. Edge device 600 interfaces with a TDM signaling linkset 104 connected to signaling point 100 and an M2PA-based signaling linkset 602 connected to signaling message routing node 400. Nodes 100 and 102 are identified point codes A and B, as previously described.

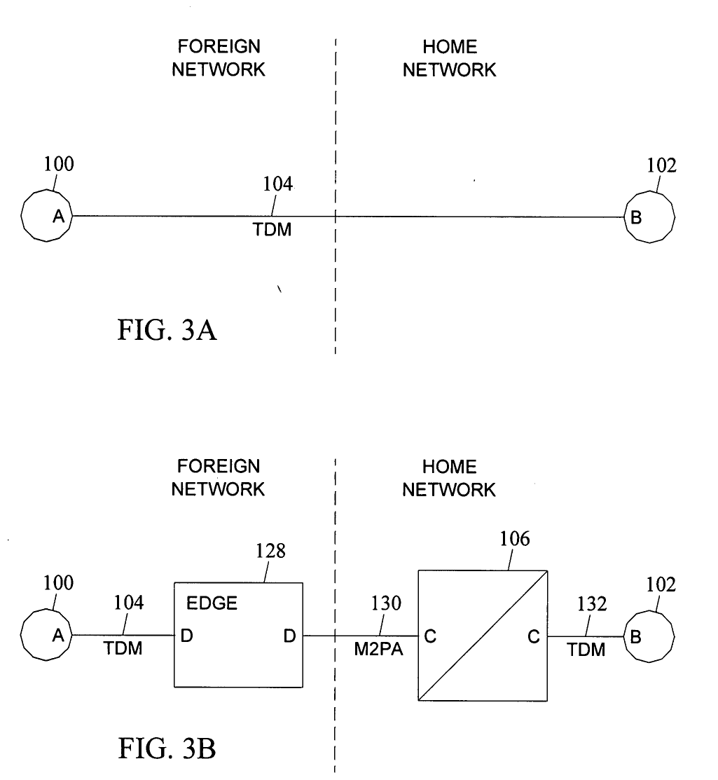

In prior implementations of edge device 600, edge device 600 would have its own separate point code, as illustrated in FIG. 3B. However, according to an embodiment of the subject matter described herein, edge device 600 may proxy point code B on signaling linkset 104 for link alignment purposes and may also proxy point code A on signaling linkset 602 for link alignment purposes. This dual proxying allows nodes 100 and 102 to use the same point codes they previously used for link alignment. Signaling message routing node 400 may proxy point code B on signaling linkset 602 and may also proxy point code A on signaling linkset 604. Thus, node 100 is not required to reprovision the adjacent point code for link alignment on linkset 104. Similarly, signaling point 102 is not required to reprovision its adjacent point code for link alignment on signaling linkset 604. Because edge device 600 proxies two point codes, no additional point codes are required to provide IP connectivity to the operator of the remote network. As a result, point codes are conserved.

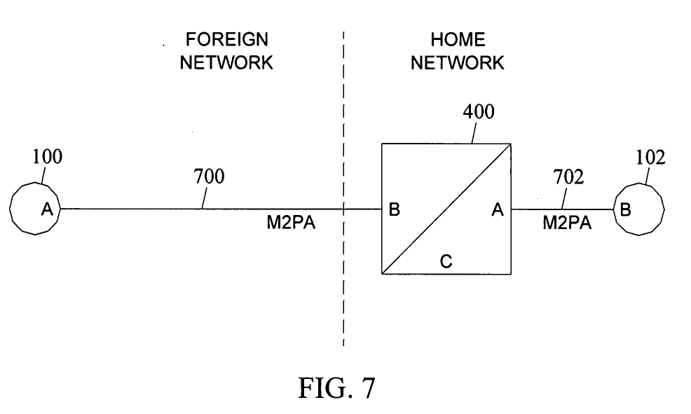

In FIG. 6, edge device 600 proxies a point code for alignment on a TDM link and another point code for link alignment on an M2PA link. In an alternate implementation, signaling message routing node 400 may be connected to M2PA links or other SIGTRAN links where link alignment is implemented and may proxy point codes on both M2PA links. FIG. 7 illustrates such an embodiment. In FIG. 7, signaling message routing node 400 is connected to nodes 100 and 102 via M2PA signaling links. Accordingly, signaling message routing node 400 may proxy point code B of node 102 for alignment with node 100 on M2PA link 700 and may proxy point code A of node 100 for link alignment on M2PA link 702 with node B 102. Accordingly, the point code proxying functionality of the subject matter described herein may be used in all-IP networks. Like the examples described above, the point code proxying illustrated in FIG. 7 can be utilized when migrating from a direct linkset interconnection (TDM-based or IP-based) between nodes 100 and 102 and an interconnection including signaling message routing node 400, as illustrated in FIG. 4.

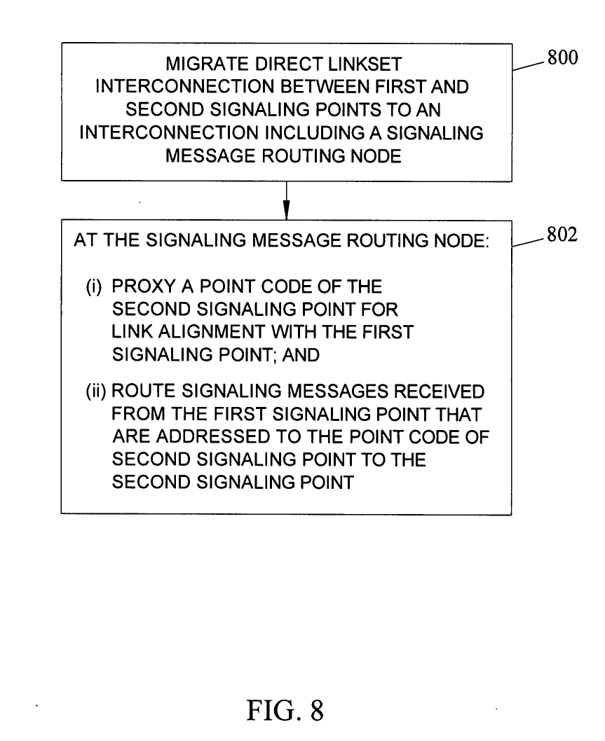

FIG. 8 is a flow chart illustrating exemplary over-all steps for point code proxying according to an embodiment of the subject matter described herein. Referring to FIG. 8, in step 800, a direct linkset interconnection between first and second signaling points is migrated to an interconnection including a signaling message routing node. For example, referring to FIG. 1A, the direct connection between nodes 100 and 102 via linkset 104 may be migrated to an interconnection involving signaling message routing node 400, as illustrated in FIG. 4.

In step 802, at the signaling message routing node, a point code of the second signaling point is proxied for link alignment with the first signaling point. Referring again to FIG. 4, point code B of signaling point 102 is proxied on linkset 104A so that signaling point 100 can continue to use point code B as the adjacent point code on linkset 104A for link alignment.

Also in step 802, signaling messages received from the first signaling point that are addressed to the second signaling point are routed to the second signaling point. Referring again to FIG. 4, signaling messages from signaling point 100 addressed to point code B are routed by signaling message routing node 400 from signaling point 100 to signaling point 102.

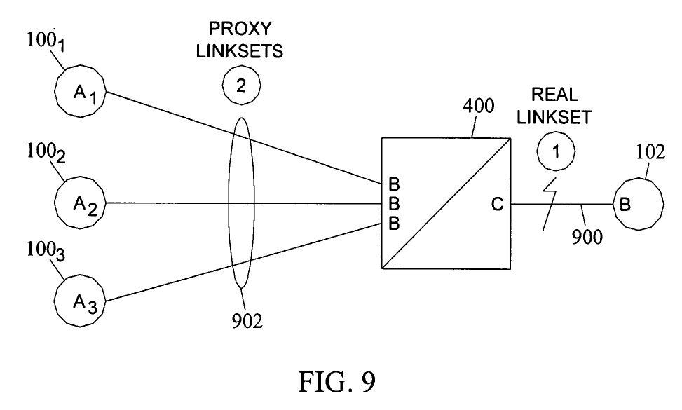

Point code proxying requires some changes to be made to link management procedures. One such change is illustrated in FIG. 9. In FIG. 9, point code B of signaling point 102 is proxied on linksets 902 connected to signaling points 100₁-100₃. Accordingly, linksets 902 are referred to as proxy linksets. Linkset 900 is referred to as a real linkset because it uses the adjacent point codes of nodes that are actually connected to each end of the linkset. In the example illustrated in FIG. 8, when a failure occurs on the real linkset, all of the proxy linksets 902 must be taken out of service. The reason that proxy linksets 902 must be taken out of service is that proxy linksets are an extension of the real linkset, and an outage on the real linkset requires that the extensions of the real linkset be taken out of service. Conversely, if any of proxy linksets 902 fails, the remaining proxy linksets and real linkset 900 can remain in service.

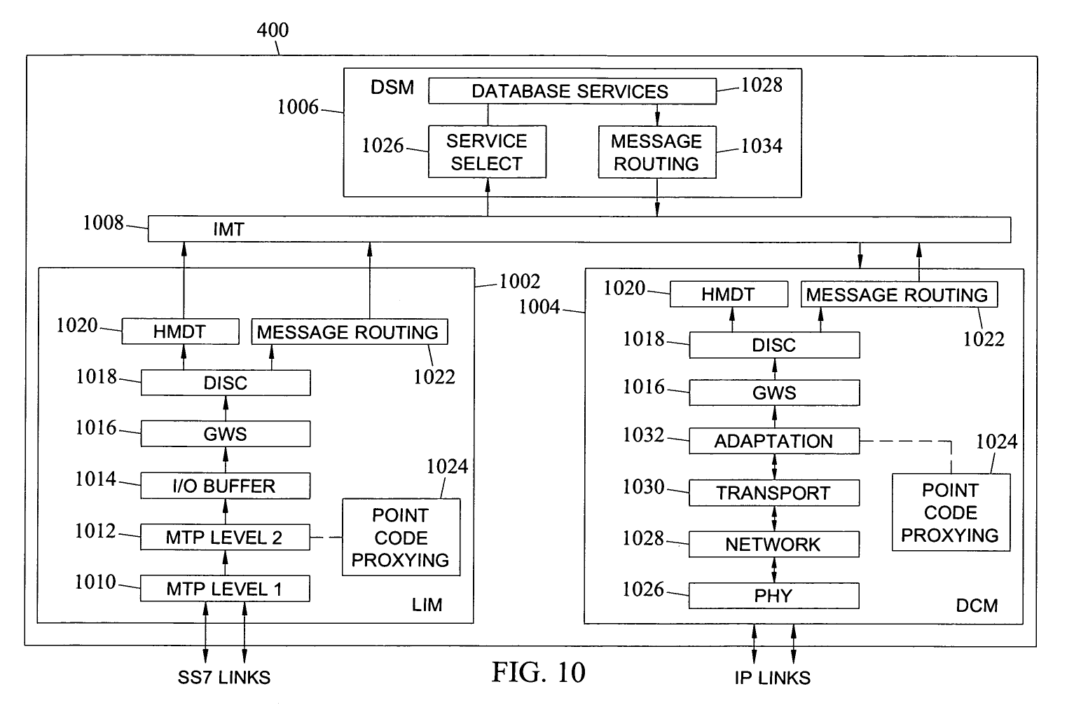

FIG. 10 is a block diagram illustrating an exemplary internal architecture for signaling message routing node 400 according to an embodiment of the subject matter described herein. Referring to FIG. 10, signaling message routing node 400 may include a plurality of internal processing modules 1002, 1004, and 1006 connected via a bus 1008. Each module 1002, 1004, and 1006 may be implemented using a printed circuit board with a communications processor, an application processor, and associated memory mounted thereon. The communications processor controls communications with other modules via bus 1008. The application processor implements signaling functions, such as the point code proxying feature described herein. Bus 1008 may be any suitable interconnection between modules 1002, 1004, and 1006. In one implementation, bus 1008 may be implemented using Ethernet.

In the illustrated example, module 1002 is a link interface module (LIM) for interfacing with TDM-based or ATM-based SS7 signaling links. Module 1002 includes an MTP level 1 function 1010, an MTP level 2 function 1012, an I/O buffer 1014, a gateway screening function 1016, a discrimination function 1018, a distribution function 1020, and a message routing function 1022. MTP level 1 function performs MTP level 1 operations, such as implementing the electrical or optical interconnection with the external signaling links. MTP level 2 function 1012 performs MTP level 2 operations, such as message sequencing, timeouts, and retransmissions. MTP level 2 function 1012 may also perform signaling link alignment. Accordingly, a sub-function of MTP level 2 function may include point code proxying function 1024. Point code proxying function 1024 may proxy the point code of a node other than that of signaling message routing node 400 for link alignment purposes. Using the example illustrated in FIG. 4, point code proxying function 1024 may proxy point code B for link alignment purposes when LIM 1002 is connected to signaling point 100 and another LIM (not illustrated in FIG. 10) is connected to signaling point 102.

I/O buffer 1014 buffers inbound and outbound signaling messages for processing by other layers. Gateway screening function 1016 screens incoming signaling messages to determine whether to allow the messages into a network. Discrimination function 1018 determines whether signaling messages require routing or internal processing my signaling message routing node 400. Discrimination function 1018 may forward messages that require internal processing to distribution function 1020. Distribution function 1020 may distribute such messages to the appropriate internal processing module, such as database services module 1006, for internal processing. Discrimination function 1018 may forward messages that require routing to message routing function 1022. Message routing function 1022 may route messages based on one or more parameters in messages to the module associated with the outbound signaling link. Using the configuration in FIG. 4 as an example, message routing function 1022 may route messages addressed to point code B to node 102 via signaling linkset 104B. Thus, the configuration illustrated in FIG. 4 and in detail in FIG. 10 allows a routable point code to be used for link alignment purposes, which was not previously allowed in signal transfer point architectures.

Module 1004 comprises a data communications module (DCM) for interfacing with IP signaling links. DCM 1010 includes a physical layer function 1026, a network layer function 1028, a transport layer function 1030, an adaptation layer function 1032, and functions 1016, 1018, 1020, and 1022 described with regard to LIM 1002. Physical layer function 1026 performs open systems interconnect (OSI) physical layer functions, such as controlling access to the underlying transmission medium. In one implementation, physical layer function 1026 may be implemented using Ethernet. Network layer function 1028 performs OSI network layer operations, such as message routing. Network layer function 1028 may be implemented using Internet protocol (IP). Transport layer function 1030 implements OSI transport layer functions, such as providing connectionless, connection oriented, or stream oriented communication of signaling messages between adjacent nodes. Transport layer function 1030 may be implemented using transmission control protocol (TCP) in applications requiring connection oriented transport, user datagram protocol (UDP) in applications requiring connectionless transport, or stream control transmission protocol (SCTP) in applications requiring stream oriented transport.

Adaptation layer 1032 performs adaptation layer operations for allowing the transport of SS7 signaling messages over IP transport. For this purpose, adaptation layer 1032 may implement of the SIGTRAN family or other family of protocols. In one example, it is assumed that adaptation layer function 1032 implements a protocol that requires a point code at each end of an IP based signaling link. An example of such a protocol is M2PA. Because a point code is required at each end of the signaling link, adaptation layer function 1032 may include a point code proxying function 1024 that proxies the point code of a node other than that of signaling message routing node 400 for link alignment purposes. Using the configuration illustrated in FIG. 6 as an example, point code proxying function 1024 of DCM 1004 may proxy point code A of signaling point 100 when DCM 1004 is connected to signaling linkset 602. LIM 1002 may proxy point code B on linkset 104 when LIM 1002 is connected to linkset 104. Such dual proxying allows nodes that were previously directly connected to be seemlessly migrated to new SS7 or IP based signaling links without extensive reprovisioning by other network operators. In addition, point codes are conserved.

Functions 1016, 1018, 1020, and 1022 of DCM 1004 perform the same functions as the correspondingly numbered functions described above with regard to LIM 1002. Hence, a description thereof will not be repeated herein. DSM 1006 performs database-related services for SS7 signaling messages identified as requiring internal processing by node 400. Examples of services that may be provided by DSM 1006 include global title translation (GTT), number portability translation, such as local number portability (LNP) translation, and application layer screening functions, such as mobile application part (MAP) screening. DSM 1006 includes a service selection function for identifying a service to be provided for a message that is identified as requiring internal processing by signaling message routing node 400. Database services function 1028 provides the selected service. Once the service is provided, message routing function 1022 routes the message to the link interface module associated with the outbound signaling link.

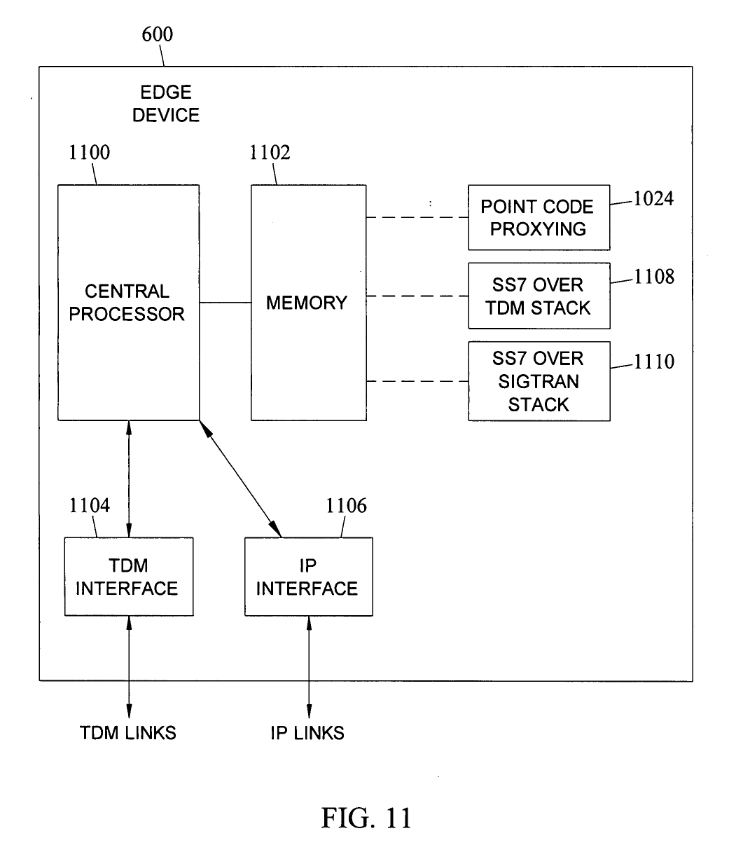

Edge device 600 illustrated in FIG. 6 may be a scaled down version of signaling message routing node 400 illustrated in FIG. 10. By scaled down, it is meant that edge device 400 may interface with a number of signaling links that is 1 to 2 orders of magnitude less than the number of signaling links with which signaling message routing node 400 interfaces. For example, signaling message routing node 400 may interface with hundreds or even thousands of signaling links while edge device 600 may interface with fewer than 10 or fewer than 100 signaling links. Signaling message routing node 400 may be a rack mounted system with multiple blades for interfacing with multiple signaling links as well as multiple other modules for providing database and other services. Edge device 600 may be a conventional “pizza box” system that includes a single processor for implementing all of the link interface functions. FIG. 11 illustrates an exemplary architecture for edge device 600 according to an embodiment of the subject matter described herein. Referring to FIG. 11, edge device 600 may include a central processor 1100, memory 1102, a TDM signaling link interface 1104, and an IP signaling link interface 1106. Central processor 1100 controls the over-all operation of edge device 600 and processes passages received via TDM signaling link interface 1104 and IP signaling link interface 1106. In order to process such packets, processor 1100 may execute one or more programs stored in memory 1102. Examples of such programs include SS7 over TDM stack 1108, SS7 over SIGTRAN stack 1110, and point code proxying function 1024. For example, for messages received over TDM signaling interface 1104, processor 1100 may process the messages by passing the messages up the layers of SS7 over TDM stack 1108, and, if the message is destined for an IP signaling link, forwarding the message to SS7 over SIGTRAN stack 1110 for encapsulation and forwarding over IP interface 1106. For messages received via IP signaling link interface 1106 that are intended for TDM links, processor 1100 may perform the reverse operation. If edge device 600 is connected as illustrated in FIG. 6, point code proxying function 1024 may proxy point code B on TDM interface 1104 and point code A on IP interface 1106.

It will be understood that various details of the presently disclosed subject matter may be changed without departing from the scope of the presently disclosed subject matter. Furthermore, the foregoing description is for the purpose of illustration only, and not for the purpose of limitation.

1. A method for point code proxying, the method comprising:
(a) migrating a direct linkset interconnection between first and second signaling points to an interconnection including a signaling message routing node; and
(b) at the signaling message routing node:
(i) proxying a point code of the second signaling point for link alignment with the first signaling point; and
(ii) routing signaling messages received from the first signaling point that are addressed to the point code of the second signaling point to the second signaling point.

2. (canceled)

3. (canceled)

4. The method of claim 1 wherein the first and second signaling points each comprise one of a switch and a database node.

5. (canceled)

6. The method of claim 1 comprising migrating a plurality of direct linkset interconnections between the first signaling point and a plurality of second signaling points with the interconnection including the signaling message routing node and proxying a plurality of point codes of the second signaling points for link alignment.

7. The method of claim 1 wherein interconnection including the signaling message routing node includes a time division multiplexed (TDM)-based linkset.

8. The method of claim 1 wherein the interconnection including the signaling message routing node includes an Internet protocol (IP)-based linkset.

9. The method of claim 8 wherein the IP-based linkset comprises an MTP layer 2-user peer-to-peer adaptation layer (M2PA) linkset.

10. The method of claim 9 comprising interconnecting the first signaling point to the IP-based linkset using an edge device that proxies the point code of the second signaling point for link alignment with the first signaling point and that proxies a point code of the first signaling point on the IP based linkset for link alignment with the signaling message routing node.

11. The method of claim 1 wherein the interconnection including the signaling message routing node includes a first Internet protocol (IP) based linkset connecting the signaling message routing node to the first signaling point and a second IP-based linkset connecting the signaling message routing node to the second signaling point.

12. The method of claim 11 wherein the first and second IP-based linksets comprise SIGTRAN linksets on which link alignment is implemented.

13. (canceled)

14. The method of claim 11 wherein the signaling message routing node proxies the point code of the second signaling point for link alignment with the first signaling point on the first IP-based linkset and wherein the signaling message routing node proxies the point code of the first signaling point to the second signaling point for link alignment with the second signaling point on the second IP-based linkset.

15. The method of claim 1 wherein the interconnection including the signaling message routing node includes a proxy linkset connecting the signaling message routing node to the first signaling point and a real linkset connecting the signaling message routing node to the second signaling point and wherein the method further comprises, in response to detecting failure of the real linkset or the second signaling point, taking the proxy linkset out of service.

16. A system for point code proxying, the system comprising:
(a) first and second signaling link interfaces for migrating a direct linkset interconnection between first and second signaling points to an interconnection including a signaling message routing node;
(b) a point code proxying function for proxying a point code of the second signaling point for link alignment with the first signaling point; and
(c) a routing function for routing messages received from the first signaling point that are addressed to the point code of the second signaling point to the second signaling point.

17. (canceled)

18. (canceled)

19. The system of claim 16 wherein the first and second signaling points each comprise one of a switch and a database node.

20. (canceled)

21. The system of claim 16 comprising a plurality of signaling link interfaces for migrating a plurality of direct linkset interconnections between the first signaling point and a plurality of second signaling points with the interconnection including the signaling message routing node and a plurality of point code proxying functions for proxying a plurality of point codes of the second signaling points for link alignment.

22. The system of claim 16 wherein the interconnection including the signaling message routing node comprises a time division multiplexed (TDM)-based linkset.

23. The system of claim 16 wherein the interconnection including the signaling message routing node comprises an Internet protocol (IP)-based linkset.

24. The system of claim 23 wherein the interconnection including the signaling message routing node comprises a SIGTRAN linkset on which point code proxying is implemented.

25. (canceled)

26. The system of claim 23 comprising an edge device for proxying the point code of the second signaling point to the first signaling point for link alignment purposes and for proxying a point code of the first signaling point on the IP-based linkset for link alignment purposes.

27. The system of claim 16 wherein the first and second signaling link interfaces comprise IP signaling link interfaces for interconnecting the first and second signaling points using first and second IP-based linksets.

28. (canceled)

29. The system of claim 27 wherein the point code proxying function is adapted to proxy the point code of the second signaling point for link alignment with the first signaling point on the first IP-based linkset and to proxy the point code of the first signaling point for link alignment with the second signaling point on the second IP-based signaling linkset.

30. The system of claim 16 wherein the interconnection including a signaling message routing node includes a proxy linkset connecting the signaling message routing node to the first signaling point and a real linkset for connecting the signaling message routing node to the second signaling point and wherein the point code proxying function is adapted to take the proxy linkset out of service in response to detecting failure of the real linkset or the second signaling point.

31. An edge device with point code proxying capability, the edge device comprising:
(a) a time division multiplexed (TDM) signaling link interface for interfacing with a TDM-based signaling linkset;
(b) an Internet protocol (IP)-based signaling link interface for interfacing with an IP-based signaling linkset; and
(c) a point code proxying function for proxying a point code of a node reachable via the IP-based signaling linkset for alignment of signaling links in the TDM based signaling linkset and for proxying a point code of a node reachable via the TDM based signaling linkset for link alignment of signaling links in the IP-based signaling linkset.

32. The edge device of claim 31 wherein the IP-based signaling link interface comprise a SIGTRAN signaling link interface on which link alignment is implemented.

33. The edge device of claim 32 wherein the SIGTRAN signaling link interface comprises an MTP layer 2-user peer-to-peer adaptation layer (M2PA) interface.

34. A computer program product comprising computer executable instructions embodied in a computer readable medium for performing steps comprising:
(a) migrating a direct linkset interconnection between first and second signaling points to an interconnection including a signaling message routing node; and
(b) at the signaling message routing node:
(i) proxying a point code of the second signaling point for link alignment with the first signaling point; and
(ii) routing signaling messages received from the first signaling point that are addressed to the point code of the second signaling point to the second signaling point.
